(19) United States
(12) Patent Application Publication
(10) Pub. No.: US 2023/0200502 A1
(43) Pub. Date: Jun. 29, 2023

(54) AUTHENTICATION OF GEMSTONES

(71) Applicant: EllansaLabs Inc., Addison, TX (US)

(72) Inventor: Omar Besim HAKIM, Addison, TX (US)

(73) Assignee: EllansaLabs Inc., Addison, TX (US)

(21) Appl. No.: 18/117,167

(22) Filed: Mar. 3, 2023

Related U.S. Application Data
(60) Provisional application No. 63/417,163, filed on Oct. 18, 2022.

(51) Int. Cl. G06Q 50/18; A44C 17/00; A44C 27/00

(52) U.S. Cl. CPC G06Q 50/184; A44C 17/002; A44C 17/007; A44C 27/00

(57) ABSTRACT

Single integrated transparent gemstones and methods for constructing single integrated transparent gemstones. The single integrated transparent gemstone includes a first transparent gemstone, a copyright protected element, and a second transparent gemstone. The first transparent gemstone includes a first internal side. The copyright protected element is etched on the first internal side. The copyright protected element is owned by a third party. The second transparent gemstone includes a second internal side. The second transparent gemstone is fused together with the first transparent gemstone. The second internal side is aligned with the first internal side such that the copyright protected element does not extend beyond a perimeter of the second internal side.

### CROSS-REFERENCE TO OTHER APPLICATIONS

The present application claims the benefit of U.S. Provisional Application No. 63/417,163, titled “AUTHENTICATION OF GEMSTONES,” filed Oct. 18, 2022, the content of which is incorporated herein by reference in its entirety for all purposes.

### BACKGROUND

Intellectual property infringement (that is, counterfeiting and piracy) are criminal behaviors and an effective way of addressing this illegal activity is by involving United States law enforcement agencies. However, the United States Department of Homeland Security has reported that “when sellers of illicit goods are in another country, they are largely outside the jurisdiction for criminal prosecution or civil liability from US law enforcement and private parties.” Many companies have learned that winning a default civil judgment or successfully bringing a matter before a grand jury (resulting in an issued criminal indictment) is a hollow victory when pursuing an overseas intellectual property infringer. Foreign countries will rarely help United States law enforcement with enforcing these judgments or indictments, particularly when the alleged behavior is not perceived to be a criminal matter within their business culture.

### SUMMARY

Many people actively producing counterfeit goods in foreign countries are most likely not enjoying their ill-gotten spoils within those foreign countries. These intellectual property infringers are likely to travel abroad from time to time. A strategy is needed for ensnaring intellectual property infringers who will unknowingly commit a type of criminal copyright infringement that may lead to rapid action from international law enforcement agencies. The present disclosure describes a two-part strategy that includes integrating registered third-party copyright-protected materials into a gemstone; and using Interpol Red Notices to rapidly apply real pressure and stress on intellectual property infringers, compelling them to stop their illegal activities. Further, the present disclosure provides, among other things, gemstone and methods for constructing gemstones with an internally-etched copyright protected element.

The present disclosure provides a single integrated transparent gemstone including, in one implementation, a first transparent gemstone, a copyright protected element, and a second transparent gemstone. The first transparent gemstone includes a first internal side. The copyright protected element is etched on the first internal side. The copyright protected element is owned by a third party. The second transparent gemstone includes a second internal side. The second transparent gemstone is fused together with the first transparent gemstone. The second internal side is aligned with the first internal side such that the copyright protected element does not extend beyond a perimeter of the second internal side.

The present disclosure also provides a method for constructing a single integrated transparent gemstone. The method includes etching, on a first internal side of a first transparent gemstone, a copyright protected element owned by a third party. The method also includes aligning the first internal side of the first transparent gemstone with a second internal side of a second transparent gemstone such that the copyright protected element does not extend beyond a perimeter of the second internal side. The method further includes fusing the first transparent gemstone and the second transparent gemstone together to create the single integrated transparent gemstone.

Other technical features may be readily apparent to one skilled in the art from the following figures, descriptions, and claims.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a block diagram of an example of a system architecture according to some implementations of the present disclosure;

FIG. 2A is a top view of an example of a single integrated transparent gemstone with a copyright protected element according to some implementations of the present disclosure;

FIG. 2B is a top view of an example of a single integrated transparent gemstone with a copyright protected element and an authentication element according to some implementations of the present disclosure;

FIG. 3A is a sectional side view of an example of a single integrated transparent gemstone with a single etching according to some implementations of the present disclosure;

FIG. 3B is a sectional side view of an example of a single integrated transparent gemstone with two etchings according to some implementations of the present disclosure;

FIG. 3C is a sectional side view of an example of a single integrated transparent gemstone with two oppositely positioned etchings according to some implementations of the present disclosure;

FIG. 4 is a flow diagram of an example of a method for constructing a gemstone according to some implementations of the present disclosure;

FIG. 5 is a flow diagram of an example of a method for validating an authentication element internally etched within a gemstone according to some implementations of the present disclosure; and

FIG. 6 is a block diagram of an example of a computer system in accordance with some implementations of the present disclosure.

### NOTATION AND NOMENCLATURE

Various terms are used to refer to particular system components. A particular component may be referred to commercially or otherwise by different names. Further, a particular component (or the same or similar component) may be referred to commercially or otherwise by different names. Consistent with this, nothing in the present disclosure shall be deemed to distinguish between components that differ only in name but not in function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example implementations only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example implementations. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” “inside,” “outside,” “contained within,” “superimposing upon,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

“Real-time” may refer to less than or equal to 2 seconds. “Near real-time” may refer to any interaction of a sufficiently short time to enable two individuals to engage in a dialogue via such user interface, and will generally be less than 10 seconds (or any suitable proximate difference between two different times) but greater than 2 seconds.

### DETAILED DESCRIPTION

The following discussion is directed to various implementations of the present disclosure. Although one or more of these implementations may be preferred, the implementations disclosed should not be interpreted, or otherwise used, as limiting the scope of the present disclosure, including the claims. In addition, one skilled in the art will understand that the following description has broad application, and the discussion of any implementation is meant only to be exemplary of that implementation, and not intended to intimate that the scope of the disclosure, including the claims, is limited to that implementation.

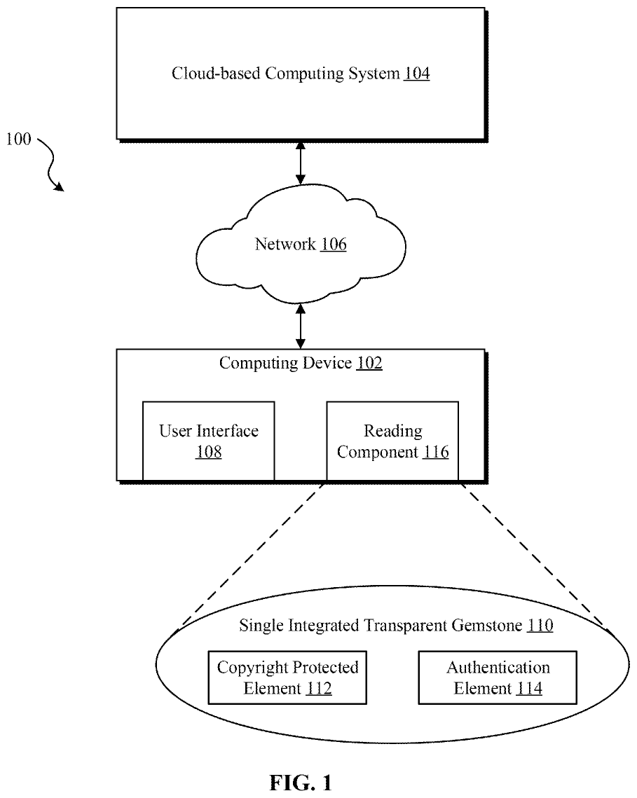

Turning now to the figures, FIG. 1 is a block diagram of an example of a system architecture 100 according to some implementations of the present disclosure. The system architecture 100 may include a computing device 102 communicatively coupled to a cloud-based computing system 104. The cloud-based computing system 104 may include one or more servers. Each of the computing device 102 and/or servers included in the cloud-based computing system 104 may include one or more processing devices, memory devices, and/or network interface devices. The network interface devices may enable communication via a wireless protocol for transmitting data over short distances, such as Bluetooth, ZigBee, NFC, etc. Additionally, the network interface devices may enable communicating data over long distances, and in one example, the computing device 102 and the cloud-based computing system 104 may communicate over a network 106. The network 106 may be a public network (e.g., connected to the Internet via wired (Ethernet) or wireless (WiFi)), a private network (e.g., a local area network (LAN) or wide area network (WAN)), or a combination thereof. The network 106 may also comprise a node or nodes on the Internet of Things (IoT).

The computing device 102 may be any suitable computing device, such as a laptop, tablet, smartphone, or computer. The computing device 102 may include a display capable of presenting a user interface 108. The user interface 108 may be implemented in computer instructions stored on the one or more memory devices of the cloud-based computing system 104 and/or computing device 102 and may be executable by the one or more processing devices of the cloud-based computing system 104 and/or computing device 102. The user interface 108 may present various screens to a user. For example, the user interface 108 may present a screen that indicates a producer of a single integrated transparent gemstone 110.

In some implementations, the user interface 108 is a stand-alone application installed and executing on the computing device 102. In some implementations, the user interface 108 (e.g., website) executes within another application (e.g., web browser). The cloud-based computing system 104 and the computing device 102 may also include instructions stored on one or more memory devices that, when executed by the one or more processing devices of the computing device 102 perform operations of any of the methods described herein.

In some implementations, the cloud-based computing system 104 may include one or more servers that form a distributed computing architecture. The servers may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers may include one or more processing devices, memory devices, data storage, and/or network interface cards. The servers may be in communication with one another via any suitable communication protocol.

The single integrated transparent gemstone 110 may be manufactured by fusing together two wafers of a gemstone as will be described in more detail below. The single integrated transparent gemstone 110 may include an internally etched copyright protected element 112 owned by a third party and/or an internally etched authentication element 114. In some implementations, the authentication element 114 identifies a producer (e.g., manufacturer, distributer, etc.) of the single integrated transparent gemstone 110. The third party who owns the copyright protected element 112 is defined herein as a different entity than the producer of the single integrated transparent gemstone 110. For example, the third party may be a different company than the company that producing the single integrated transparent gemstone 110.

In some implementations, the copyright protected element 112 includes a haiku poem. A haiku poem is an original and creative English-language non-rhyming poem like a sonnet with a three-line format with seventeen syllables arranged in a five—seven—five pattern, with five syllables in the first line, seven syllables in the second line, and five syllables in the third line. Below is one non-limiting example of a haiku poem:

### Legal snares capture

### swamp bandits making their copies

### and this is justice

A haiku poem is not a short phrase that is not entitled to copyright protection, but is a complete creative and original work of literature that is covered by United States and international copyright law, including the Berne Convention for the Protection of Literary and Artistic Works. A haiku poem can be registered with the United States Copyright Office, and its unauthorized infringement is enforceable under civil and criminal law in the United States Federal Courts and international courts.

Returning to FIG. 1, the computing device 102 may include a reading component 116. The reading component 116 may be a sensor and/or a camera. The single integrated transparent gemstone 110 may be placed proximately to or touch the reading component 116, and the reading component 116 may perform an operation to read the copyright protected element 112 owned by a third party and/or the internally etched authentication element 114 included internally within the single integrated transparent gemstone 110. For example, the reading component 116 may be a camera and may obtain or stream an image of the single integrated transparent gemstone 110. A processing device of the computing device 102 may receive the image and perform optical character recognition to decipher the authentication element 114 that is internally etched within the single integrated transparent gemstone 110. The computing device 102 may transmit the authentication element 114 to the cloud-based computing system 104 to obtain data related to a producer of the single integrated transparent gemstone 110.

The single integrated transparent gemstone 110 may be produced by etching the copyright protected element 112 and/or the authentication element 114 on a gemstone surface during (e.g., in the middle of) a growing process of the gemstone, and the single integrated transparent gemstone 110 may be grown to a state where the copyright protected element 112 and/or the authentication element 114 is internally included within the single integrated transparent gemstone 110 such that it is not physically exposed to elements outside an outer surface of the single integrated transparent gemstone 110. The copyright protected element 112 and/or the authentication element 114 may be wholly included within an outer surface perimeter of the single integrated transparent gemstone 110.

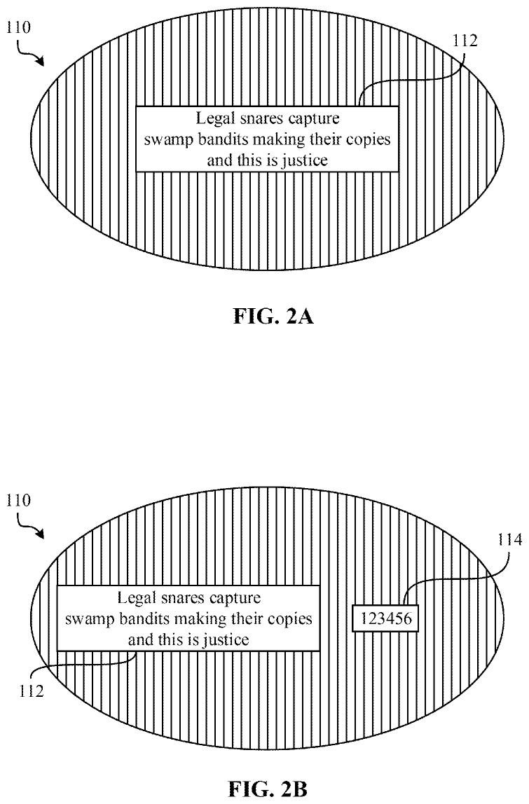

FIG. 2A is top view of an example of the single integrated transparent gemstone 110 in which the copyright protected element 112 includes human-readable text of a haiku poem. FIG. 2B is top view of an example of the single integrated transparent gemstone 110 including the copyright protected element 112 and the authentication element 114. The authentication element 114 illustrated in FIG. 2B includes human-readable text (“123456”) to be read, either by the naked eye or with a magnifying object or the reading component 116 of the computing device 102.

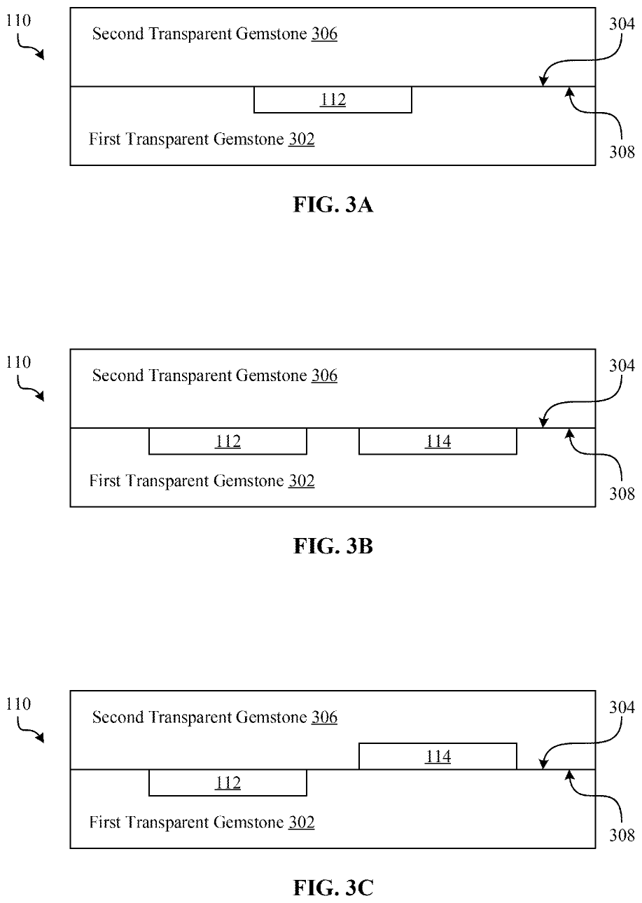

FIG. 3A is a sectional side view of an example of the single integrated transparent gemstone 110 with a single etching according to some implementations of the present disclosure. As illustrated, a first transparent gemstone 302 includes a first internal side 304, and a second transparent gemstone 306 includes a second internal side 308. The first internal side 304 includes an etching of the copyright protected element 112 that is recessed due to a laser etching machine, for example. The etching may be filled with a material, in some implementations. The material may include a mineral material, such as a metal and/or liquid (e.g., paint). The etching may be sized smaller than can be viewed by the naked eye (e.g., less than 0.1 millimeter), in some implementations. Alternatively, the etching may be bigger than visible to the naked eye (e.g., more than 0.1 millimeter). Each of the first transparent gemstone 302 and the second transparent gemstone 306 may be sapphire, diamond, or the like. As depicted, the etching of the copyright protected element 112 may be encapsulated within a perimeter of the single integrated transparent gemstone 110 such that it does not extend beyond the perimeter. In this way, a hermetic seal is created after the first transparent gemstone 302 and the second transparent gemstone 306 are molecularly fused together.

The single integrated transparent gemstone 110 may also include an etching of the authentication element 114. In some implementations, the authentication element 114 is etched on the first internal side 304 of the first transparent gemstone 302, as illustrated in FIG. 3B. Alternatively, the authentication element 114 is etched on the second internal side 308 of the second transparent gemstone 306, as illustrated in FIG. 3C.

In some implementations, the single integrated transparent gemstone 110 may be grown in a lab from sapphire or diamond such that there is no fusion of two transparent gemstones. In some implementations, the copyright protected element 112 and/or the authentication element 114 are etched during a growing process (e.g., in the middle of the growing process) and the copyright protected element 112 and/or the authentication element 114 are etched on a surface of the partially grown version of the single integrated transparent gemstone 110. Once the copyright protected element 112 and/or the authentication element 114 are etched on the gemstone surface, the growing process may continue such that the copyright protected element 112 and/or the authentication element 114 are included internally within a fully grown implementation of the single integrated transparent gemstone 110. The gemstone may include obtaining a small slice of a gemstone and placing the gemstone in a crucible container. A chamber of the crucible container may be filled with ingredients (e.g., a blended liquid of minerals) that feeds the gemstone growth, and the growth may be accomplished at a certain temperature (e.g., 1,000 degrees Celsius) or within a range of temperatures (e.g., 1,000 degrees Celsius to 1,500 degrees Celsius). The gemstone may be grown naturally by recreating conditions in which gems grow in the earth. The chamber may be sealed with and pressure may be added to the chamber. A combination of ingredients, heat, and pressure may be applied for a certain period of time to enable the gem to crystallize and grow. To grow a diamond in a lab, carbon may be exposed to high pressure and temperature in a controlled environment for a certain amount of time (e.g., ten to twelve months).

During the growing process, the conditions (e.g., pressure and temperature) may be modified to enable the growing gemstone to be accessed within the chamber and laser-etched with the copyright protected element 112 and/or the authentication element 114. The partially grown gemstone may be placed under the growing conditions again so growth of the gemstone may begin again and the copyright protected element 112 and/or the authentication element 114 included within the outer edge and/or surface of the fully grown gemstone.

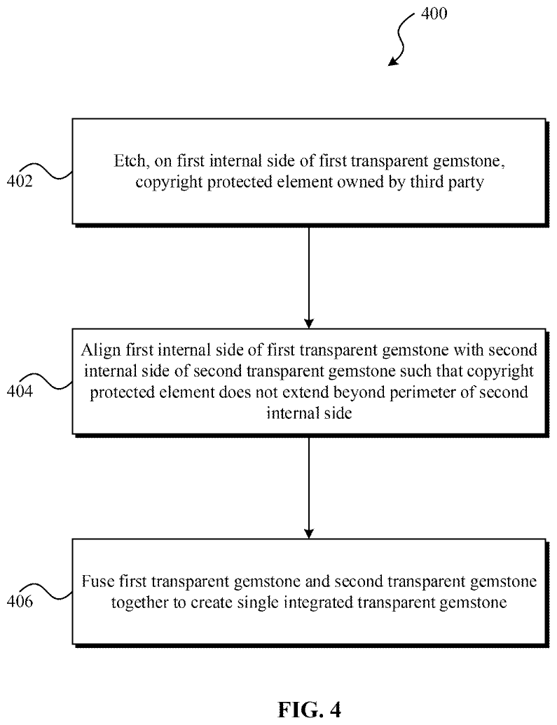

FIG. 4 is a flow diagram of an example of a method 400 for constructing the single integrated transparent gemstone 110 according to some implementations of the present disclosure. At block 402, the copyright protected element 112 owned by a third party is etched on the first internal side 304 of the first transparent gemstone 302. In some implementations a laser etching machine may etch the copyright protected element 112 on the first internal side 304 of the first transparent gemstone 302. The laser etching and/or engraving machine may include a laser, a controller, and a surface. The laser may emit a high quality monochromatic beam that allows the controller to trace patterns onto the surface. The laser may etch out and/or engrave out material of the substrate being targeted (e.g., the sapphire). In some implementations, a material is added to the recession created by the etching such that the material fills the recession. The material may be detected and/or scanned by the reading component 116 of the computing device 102 performing optical character recognition, computer vision, or the like.

The copyright protected element 112 may include a haiku poem. The haiku poem may be machine-readable and/or human-readable. For example, the copyright protected element 112 may include a human-readable text of a haiku poem or a machine-readable image of a haiku poem. In some implementations, the haiku poem is etched to a size that is not visible to the naked eye (e.g., less than 0.1 millimeter) on the internal side of the first transparent gemstone 302. In some implementations, the haiku poem is etched to a size that is readable by the naked eye of a human (e.g., greater than 0.1 millimeter). In some implementations, the gemstone is a sapphire, precious stone, diamond, etc.

At block 404, the first internal side 304 of the first transparent gemstone 302 is aligned with the second internal side 308 of the second transparent gemstone 306 such that the copyright protected element 112 does not extend beyond the perimeter of the second internal side 308. At block 406, the first transparent gemstone 302 and the second transparent gemstone 306 are fused together to create the single integrated transparent gemstone 110 including the internally etched information. The fusing may provide a hermetic seal that prevents the copyright protected element 112 from being exposed to gas, pressure, etc. In some implementations, the single integrated transparent gemstone 110 may be attached to a piece of jewelry (e.g., a necklace, a bracelet, an anklet, a ring, an earring, etc.).

In some implementations, the method 400 may include sealing the single integrated transparent gemstone 110 in an opaque material such that the copyright protected element 112 is not visible. The opaque material may include clay, wax, rubber, plastic, paper, etc. To view the copyright protected element 112 included internally within the single integrated transparent gemstone 110, the opaque material may be removed, peeled, cracked, broken, etc. Once the opaque material is removed, the single integrated transparent gemstone 110 may be examined to identify and determine the copyright protected element 112 internally etched within the single integrated transparent gemstone 110.

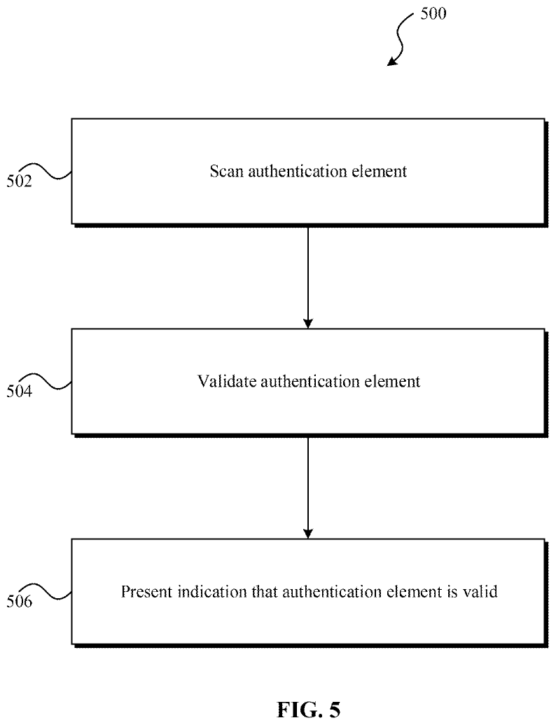

FIG. 5 illustrates an example of a method 500 for validating an authentication element 114 etched on a single integrated transparent gemstone 110 according to some implementations of the present disclosure. The method 500 may be performed by processing logic that may include hardware (circuitry, dedicated logic, etc.), software, or a combination of both. The method 500 and/or each of their individual functions, subroutines, or operations may be performed by one or more processors of a computing device (e.g., any component of cloud-based computing system 104 and/or the computing device 102 of FIG. 1) implementing the method 500. The method 500 may be implemented as computer instructions stored on a memory device and executable by the one or more processors. In certain implementations, the method 500 may be performed by a single processing thread. Alternatively, the method 500 may be performed by two or more processing threads, each thread implementing one or more individual functions, routines, subroutines, or operations of the methods.

At block 502, the computing device 102 scans the authentication element 114 etched internally within the single integrated transparent gemstone 110. The authentication element 114 may be machine-readable (e.g., a barcode, a quick response code, binary, alphanumeric characters, etc.). In some implementations, the single integrated transparent gemstone 110 may be sapphire, diamond, or another gemstone. In some implementations, the single integrated transparent gemstone 110 may be a one-inch disk, a two-inch disk, a three-inch disk, or a four-inch disk. The single integrated transparent gemstone 110 may be inserted into the computing device 102 that uses the reading component 116 (e.g., sensor, camera, etc.) to scan the authentication element 114 and the authentication element 114 may be processed using optical character recognition or other suitable techniques via a processing device of the computing device 102. In some implementations, the authentication element 114 may include text and/or an image that is etched internally within the single integrated transparent gemstone 110. At block 504, the computing device 102 validates the authentication element 114. For example, the computing device 102 may validate the authentication element 114 by determining whether or not the authentication element 114 is associated with a producer. Alternatively, or in addition, the computing device 102 may validate the authentication element 114 by determining whether the producer identified by the authentication element 114 matches the producer of the single integrated transparent gemstone 110 believed by its owner or possessor. At block 506, the computing device 102 presents an indication that the authentication element 114 is valid. For example, the computing device 102 may present the indication on the user interface 108 of the computing device 102.

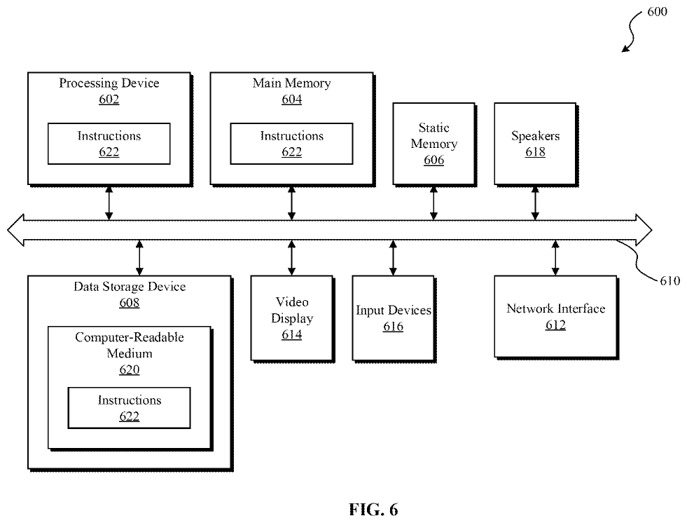

FIG. 6 illustrates an example of a computer system 600, which can perform any one or more of the methods described herein. In one example, computer system 600 may include one or more components that correspond to the computing device 102 and/or one or more servers of the cloud-based computing system 104 of FIG. 1. The computer system 600 may be connected (e.g., networked) to other computer systems in a LAN, an intranet, an extranet, or the Internet. The computer system 600 may operate in the capacity of a server in a client-server network environment. The computer system 600 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 600 includes a processing device 602, a main memory 604 (e.g., read-only memory (ROM), solid state drive (SSD), flash memory, dynamic random access memory (DRAM) such as synchronous DRAM (SDRAM)), a static memory 606 (e.g., solid state drive (SSD), flash memory, static random access memory (SRAM)), and a data storage device 608, which communicate with each other via a bus 610.

The processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions for performing any of the operations and steps of any of the methods discussed herein.

The computer system 600 may further include a network interface device 612. The computer system 600 also may include a video display 614 (e.g., a liquid crystal display (LCD) or a cathode ray tube (CRT)), input devices 616 (e.g., a keyboard and/or a mouse), and speakers 618 (e.g., a speaker). In one illustrative example, the video display 614 and the input devices 616 may be combined into a single component or device (e.g., an LCD touch screen).

The data storage device 608 may include a computer-readable medium 620 on which the instructions 622 embodying any one or more of the methodologies or functions described herein are stored. The instructions 622 may also reside, completely or at least partially, within the main memory 604 and/or within the processing device 602 during execution thereof by the computer system 600. As such, the main memory 604 and the processing device 602 also constitute computer-readable media. The instructions 622 may further be transmitted or received over the network 106 via the network interface device 612.

While the computer-readable medium 620 is shown in the illustrative examples to be a single medium, the term “computer-readable medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The present disclosure also provides a method for authenticating an article of manufacture. The method includes obtaining an article of manufacture. The article of manufacture is any physical item, or good that is manufactured and sold. The article has a first authentication item. The “first authentication item” may refer to any elements of an article of manufacture that identify the origin, maker or the producer of the article of manufacture. This includes, but is not limited to, trademarks and trade dress, logos, slogans, any copyright protected items like images or patterns. The first authentication item can be printed on an article of manufacture, it can be affixed to it, it can be imprinted on it, or it can be embedded inside of it. The method also includes affixing a second authentication item to the article. The second authentication item includes a registered copyright work. The registered copyright work includes a haiku poem owned by a third party. The second authentication item can be a physical item, such as a tag, a radio-frequency identification (RFID) chip, a metal plate, a cloth panel, and cloth tag, a paper tag, a hanging tag, or any other item that can be affixed to or embedded in an article of manufacture. The second authentication item can display the haiku poem in text format, QR code, RFID tag, or any other human or machine-readable format.

Companies experiencing intellectual property infringement can partner with third-party rights holders (“3PRHs”) who can license their registered works to companies for integration into their products, product packaging, or materials. For example, an instruction manual for a product could be licensed from a 3PRH, and enclosed within a product's packaging. When the product is illegally copied, the enclosed instruction manual may also be copied unlawfully.

If foreign intellectual property infringers are counterfeiting a company's product, then multiple crimes may be alleged—for example, trademark infringement, patent infringement, trade dress infringement—the least of which is copyright infringement of an instruction manual. Under the legal doctrine of a “lesser included offense,” it is unlikely that a court will rule on a copyright infringement matter by itself until all other issues are addressed, litigation, and resolved.

If an instruction manual is illegally copied, then the 3PRH is the party that is primarily harmed since its sole source of revenues comes from instruction manual licensing fees. The 3PRH can file a simple lawsuit in court for a single count of civil copyright infringement and seek a rapid default judgment, since the foreign intellectual property infringers are unlikely to respond to summons and appear before the court.

Historically, the courts have been comfortable issuing default judgments on single-count civil copyright infringement matters, particularly when statutory damages are sought. Statutory damages for willful copyright infringement don't require damages models to be created or presented to the court.

Once the court issues a default judgment for civil copyright infringement, usually between six to twelve months after the lawsuit has been filed, the 3PRH can approach a United States law enforcement agency on behalf of the company. The 3PRH can ask the law enforcement agency to open a criminal investigation and seek a grand jury indictment (based upon the default judgment for civil copyright infringement) against each of the individual intellectual property infringers named in the civil lawsuit. The law enforcement agency can use the grand jury indictment to seek an Interpol Red Notice against the individual intellectual property infringers.

The International Criminal Police Organization, commonly known as Interpol, is an international organization that facilitates worldwide police cooperation and crime control. Interpol coordinates the international law enforcement activities of all its member states. An Interpol notice is an international alert circulated by Interpol to all member states at the request of a law enforcement agency in any member state. An Interpol Red Notice is a request by a member state to detain a wanted individual. It has significant impacts. For example, a person with an Interpol Red Notice will be unable to travel anywhere in the world for fear of being detained by local immigration and border control officials. Also, the Interpol Red Notice process also bypasses any protections offered by the intellectual property infringer's home country, since the enforcement of Interpol Red Notices falls upon the law enforcement agencies of other member countries. Further, an Interpol Red Notice issued for criminal copyright infringement places a Red Notice flag on the passports used by intellectual property infringers that is indistinguishable from the Red Notices issued for those wanted for terrorism, child pornography, and the trafficking of illegal drugs and arms. Interpol has been willing to issue Red Notices for matters that involve a single indictment for criminal copyright infringement since copyright infringement is a criminal matter within the legal systems of most member countries, due in large part to the Berne Convention.

Any United States law enforcement agency or Unites States attorney can request that an Interpol Red Notice be placed on the passports of foreign intellectual property infringers indicted for criminal copyright infringement, severely restricting their ability to travel or conduct international business. International travel could trigger an arrest and extradition proceedings. The mere issuance of this Interpol Red Notice may be enough to force foreign intellectual property infringers to contact infringed companies and preemptively negotiate for the removal of the Red Notice. In such cases, infringed companies may receive relief from ongoing intellectual property infringement long before completing any United States criminal justice process.

Consistent with the above disclosure, the examples of systems and methods enumerated in the following clauses are specifically contemplated and are intended as a non-limiting set of examples.

Clause 1. A single integrated transparent gemstone comprising:

a first transparent gemstone having a first internal side;

a copyright protected element etched on the first internal side, wherein the copyright protected element is owned by a third party; and

a second transparent gemstone having a second internal side and fused together with the first transparent gemstone, wherein the second internal side is aligned with the first internal side such that the copyright protected element does not extend beyond a perimeter of the second internal side.

Clause 2. The single integrated transparent gemstone of any clause herein, wherein the copyright protected element includes a haiku poem.

Clause 3. The single integrated transparent gemstone of any clause herein, wherein the copyright protected element further includes human-readable text of the haiku poem.

Clause 4. The single integrated transparent gemstone of any clause herein, wherein the copyright protected element further includes a machine-readable image of the haiku poem.

Clause 5. The single integrated transparent gemstone of any clause herein, further comprising an authentication element etched on the first internal side or the second internal side, wherein the authentication element identifies a producer of the single integrated transparent gemstone.

Clause 6. The single integrated transparent gemstone of any clause herein, wherein the authentication element includes human-readable text or a machine-readable image.

Clause 7. A system comprising:

the single integrated transparent gemstone of any clause herein; and

a computing device configured to execute instructions that cause the computing device to:
scan the authentication element,
validate the authentication element, and
present an indication that the authentication element is validated.

Clause 8. The single integrated transparent gemstone of any clause herein, wherein the computing device is configured to use optical character recognition to scan the authentication element.

Clause 9. The single integrated transparent gemstone of any clause herein, wherein the single integrated transparent gemstone further comprises sapphire.

Clause 10. The single integrated transparent gemstone of any clause herein, wherein the single integrated transparent gemstone further comprises a precious stone.

Clause 11. A method of constructing a single integrated transparent gemstone, the method comprising:

etching, on a first internal side of a first transparent gemstone, a copyright protected element owned by a third party;

aligning the first internal side of the first transparent gemstone with a second internal side of a second transparent gemstone such that the copyright protected element does not extend beyond a perimeter of the second internal side; and

fusing the first transparent gemstone and the second transparent gemstone together to create the single integrated transparent gemstone.

Clause 12. The method of any clause herein, wherein the copyright protected element includes a haiku poem.

Clause 13. The method of any clause herein, wherein the copyright protected element further includes human-readable text of the haiku poem.

Clause 14. The method of any clause herein, wherein the copyright protected element further includes a machine-readable image of the haiku poem.

Clause 15. The method of any clause herein, further comprising:

etching, on the first internal side or the second internal side, an authentication element that identifies a producer of the single integrated transparent gemstone.

Clause 16. The method of any clause herein, wherein the authentication element includes human-readable text or a machine-readable image.

Clause 17. The method of any clause herein, further comprising:

scanning the authentication element with a computing device;

validating the authentication element with the computing device; and

presenting, with the computing device, an indication of that the authentication element is validated.

Clause 18. The method of any clause herein, wherein validating the authentication element with the computing device further includes validating the authentication element using optical character recognition.

Clause 19. The method of any clause herein, wherein the single integrated transparent gemstone further includes sapphire.

Clause 20. The method of any clause herein, wherein the single integrated transparent gemstone further includes a precious stone.

No part of the description in this application should be read as implying that any particular element, step, or function is an essential element that must be included in the claim scope. The scope of patented subject matter is defined only by the claims. Moreover, none of the claims is intended to invoke 25 U.S.C. § 104(f) unless the exact words “means for” are followed by a participle.

The foregoing description, for purposes of explanation, use specific nomenclature to provide a thorough understanding of the described embodiments. However, it should be apparent to one skilled in the art that the specific details are not required to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present invention. Once the above disclosure is fully appreciated, numerous variations and modifications will become apparent to those skilled in the art. It is intended that the following claims be interpreted to embrace all such variations and modifications.

What is claimed is:

1. A single integrated transparent gemstone comprising:
a first transparent gemstone having a first internal side;
a copyright protected element etched on the first internal side, wherein the copyright protected element is owned by a third party; and
a second transparent gemstone having a second internal side and fused together with the first transparent gemstone, wherein the second internal side is aligned with the first internal side such that the copyright protected element does not extend beyond a perimeter of the second internal side.

2. The single integrated transparent gemstone of claim 1, wherein the copyright protected element includes a haiku poem.

3. The single integrated transparent gemstone of claim 2, wherein the copyright protected element further includes human-readable text of the haiku poem.

4. The single integrated transparent gemstone of claim 2, wherein the copyright protected element further includes a machine-readable image of the haiku poem.

5. The single integrated transparent gemstone of claim 1, further comprising an authentication element etched on the first internal side or the second internal side, wherein the authentication element identifies a producer of the single integrated transparent gemstone.

6. The single integrated transparent gemstone of claim 5, wherein the authentication element includes human-readable text or a machine-readable image.

7. A system comprising:
the single integrated transparent gemstone of claim 5; and
a computing device configured to execute instructions that cause the computing device to:
scan the authentication element,
validate the authentication element, and
present an indication that the authentication element is validated.

8. The single integrated transparent gemstone of claim 7, wherein the computing device is configured to use optical character recognition to scan the authentication element.

9. The single integrated transparent gemstone of claim 1, wherein the single integrated transparent gemstone further comprises sapphire.

10. The single integrated transparent gemstone of claim 1, wherein the single integrated transparent gemstone further comprises a precious stone.

11. A method for constructing a single integrated transparent gemstone, the method comprising:
etching, on a first internal side of a first transparent gemstone, a copyright protected element owned by a third party;
aligning the first internal side of the first transparent gemstone with a second internal side of a second transparent gemstone such that the copyright protected element does not extend beyond a perimeter of the second internal side; and
fusing the first transparent gemstone and the second transparent gemstone together to create the single integrated transparent gemstone.

12. The method of claim 11, wherein the copyright protected element includes a haiku poem.

13. The method of claim 12, wherein the copyright protected element further includes human-readable text of the haiku poem.

14. The method of claim 12, wherein the copyright protected element further includes a machine-readable image of the haiku poem.

15. The method of claim 11, further comprising:
etching, on the first internal side or the second internal side, an authentication element that identifies a producer of the single integrated transparent gemstone.

16. The method of claim 15, wherein the authentication element includes human-readable text or a machine-readable image.

17. The method of claim 15, further comprising:
scanning the authentication element with a computing device;
validating the authentication element with the computing device; and
presenting, with the computing device, an indication of that the authentication element is validated.

18. The method of claim 17, wherein validating the authentication element with the computing device further includes validating the authentication element using optical character recognition.

19. The method of claim 11, wherein the single integrated transparent gemstone further includes sapphire.

20. The method of claim 11, wherein the single integrated transparent gemstone further includes a precious stone.
